(19) United States
(12) Patent Application Publication
(10) Pub. No.: US 2005/0215404 A1
(43) Pub. Date: Sep. 29, 2005

(54) Box made of cardboard or a similar material including an additional separate compartment

(76) Inventor: Camilla Maffei, Pistoia (IT)

Correspondence Address: MCGLEW & TUTTLE, PC, P.O. BOX 9227, SCARBOROUGH STATION, SCARBOROUGH, NY, 10510-9227, US

(21) Appl. No.: 10/520,057

(22) PCT Filed: Jul. 2, 2003
(86) PCT No.: PCT/IT03/00415

§ 371 Date: Dec. 29, 2004

(30) Foreign Application Priority Data
Jul. 5, 2002 (IT) FI2002A000117

(51) Int. Cl. B31B 1/36

(52) U.S. Cl. 493/71

(57) ABSTRACT

To form the additional compartment, one (1) of the two faces does not have a closing wall and is provided with an opening (19); the glued appendage (9) is approximately shaped like the side (7) to which it is glued and extends to form both the dividing wall (11) that is shaped like a face and is internally adjacent to the face (1) with the opening (19), and a successive appendage destined to be positioned internally against the other side (3) of said two sides (3,7).

### DESCRIPTION

The subject of the invention is a box made of cardboard or a similar material, for the packaging of products—especially medicines—that require an instruction and/or information sheet to be included with the content of the box.

Various solutions are already known for combining the aforementioned during packaging at source, but these solutions are not satisfactory with regards to the aspects of cost, practicality and reliability of the combination, excluding possible errors, the integrity of the packaging in its entirety during handling from production to the final consumer, and the possibility of being able to exploit a space sufficient for instruction and information sheets, taking into account the frequent need for multilingual versions, and so on.

This invention satisfactorily meets all of these requirements, as will become evident in the following.

The subject of the invention is substantially a box in cardboard or a similar material for medicines or other products, of a type including an additional compartment, separated with respect to the main compartment by a dividing wall and—due to the shape of the box—resulting in four sections forming two opposite faces and two opposite sides, an appendage for gluing on the inside of one of the sides and also two opposite closing walls, one of which can be opened.

In accordance with the invention, one of the two faces has an opening and is devoid of a closing wall, and the glued appendage is shaped like one of the sides and extends to form both said dividing wall, shaped like a face and positioned internally next to said face with the opening, and a successive appendage destined to be positioned inside and against the other of said two sides. The additional compartment is defined by said dividing wall and said face.

The closing wall where the aperture for access to the additional compartment is located can extend from said dividing wall, or from the opposite face to that along which said additional compartment is located, said closing wall leaving the aperture for access to the additional compartment uncovered in all cases.

The opening can advantageously be defined by incomplete cut lines, to secure at least part of the material corresponding to the opening; in this way it is necessary to remove this material to allow the sheet contents—a folded piece of paper or otherwise—of said additional compartment to be slid out. This renders it easy to check if the packaging has been tampered with, as the sheet contents can be inserted at a certain distance from the aperture for access to the additional compartment, such that it is necessary to remove the material corresponding to said opening in order slide said contents such that it protrudes from the access aperture.

The information sheet is conveniently folded a number of times, stabilized in the folded format, and lightly glued to the cardboard material of the box. Preferably, said information sheet can be glued to the portion that must be removed to allow extraction of said sheet.

Another subject of the invention is a procedure for the automated production of a box of the above-described type. A dividing wall and a contiguous appendage destined to create a stabilizing flap for said wall are created in the formation of the punched part for the box. Said dividing wall can be formed as an extension of the flap destined to be glued to form the body of the box.

To automate production, provision is made for the information sheet to be folded, stabilized by a tear-off adhesive tab and—after slight gluing—fed during manufacture of the box so that it can be glued onto one of the walls of the additional compartment during the paper-product machining processes.

The outside face can be advantageously provided with an opening covered by a portion held on by sections that can be torn to aid removal of said portion. In this case, the sheet can be glued to the internal surface of said portion so that the folded sheet is easy to extract when said portion is removed.

The invention will be better understood following the description and enclosed drawings, which represent a non-limitative practical embodiment of the invention. In the drawings:

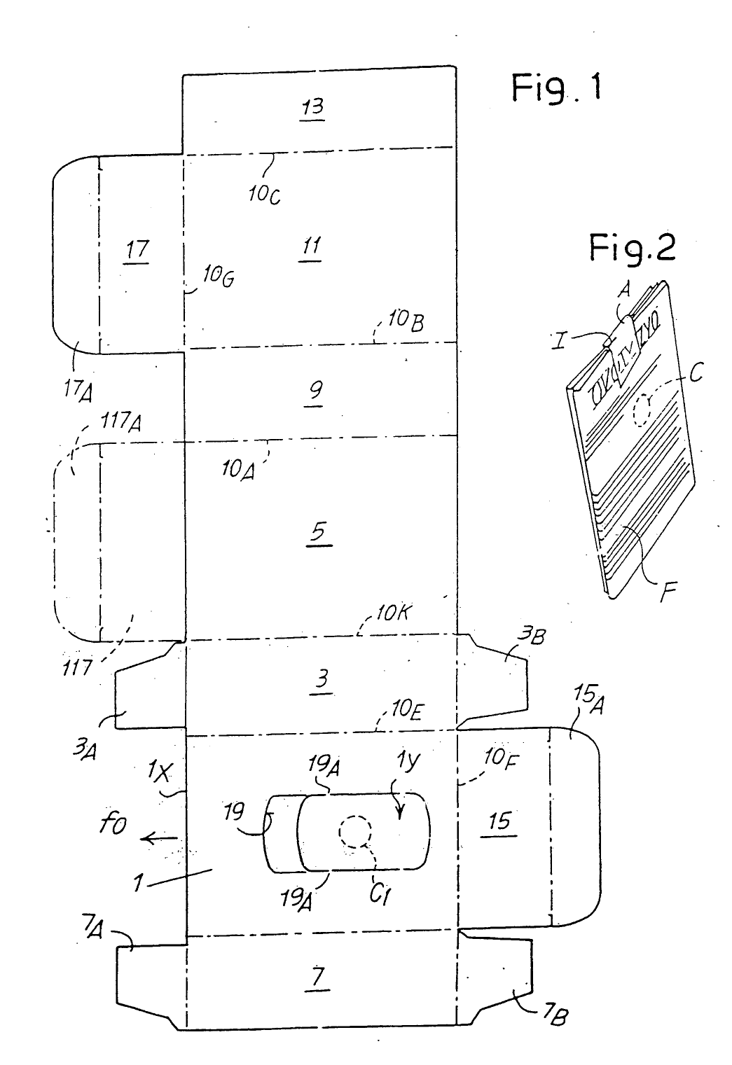

FIG. 1 shows the layout of the punched element forming the box,

FIG. 2 shows an isolated information sheet packed for processing,

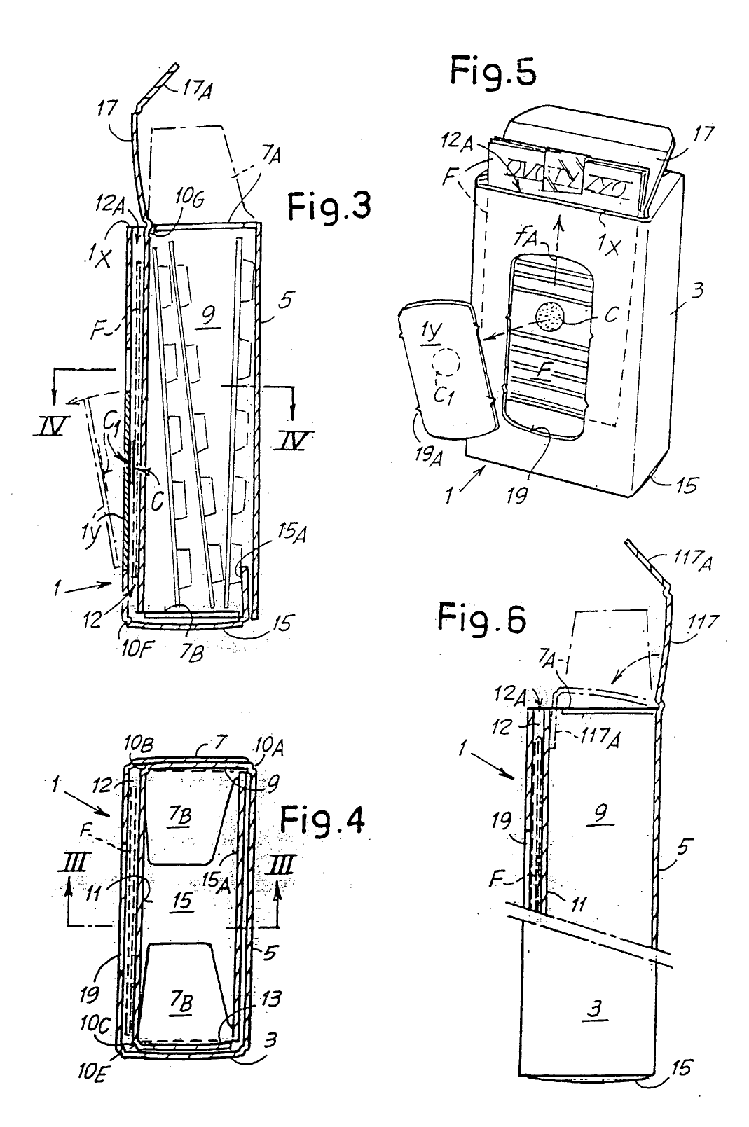

FIGS. 3 and 4 show a cross-section III-III in FIG. 4 and a cross-section IV-IV in FIG. 3,

FIG. 5 shows a perspective view of the box when half open,

FIG. 6 shows a variant with a partial sectional view similar to that of FIG. 3.

According to what is illustrated in the enclosed drawings, reference 1 indicates one of the two main faces of the box, which is flanked by one of the two sides 3 of the box, and then continues with a second main face 5; a second side 7 of the box is provided at the opposite end from side 3 with respect to face 1. References 3A and 3B indicate the tabs that extend from the two opposite edges side 3, while 7A and 7B indicate the tabs that extend from the two opposite edges side 7 of the box. Reference 9 indicates a rectangular area that extends beyond the line 10A delimiting face 5, to constitute the flap for joining and closing the perimeter of the box, by gluing it onto the internal surface of side 7; this flap 9 is composed of a rectangular area that is substantially shaped like side 7. Characteristically, beyond the fold line 10B, the opposite of fold line 10A, a dividing wall 11 is formed, which is destined to be positioned inside the volume defined by the parts 1, 3, 5 and 9 and in close proximity to face 1 in order to create an additional compartment 12, similar to a pocket, which is delimited by the wall 11 and face 1. Beyond the fold line 10C, which is opposite to the fold line 10B delimiting the dividing wall 11, another appendage extends in the form of a flap 13; this flap 13 has a shape substantially corresponding to that of the flap 9 and to the sides 3 and 7, for the purpose mentioned here below.

To form the box, the zones 7, 1, 3, 5 and 9 are folded orthogonally to each other such that side 7 coincides with flap 9, which is glued to the inside of side 7; the set of sides defining the body of the box are flattened in the traditional manner during production, with flap 9 inside of side 7. During assembly, as defined herein, the dividing wall 11 is internally lined up with face 1 and flap 13, contiguous with said dividing wall 11, will be in correspondence with and facing the inside of the side 3 of the box. When the box is arranged to assume its useful prismatic volume, the fold line 10C will correspond with the fold line 10E that separates face 1 from side 3, as can be clearly seen in section in FIG. 3. This disposition of the wall 11 and the flap 13 is maintained by the possible interaction between the end edge of flap 13 and the corner 10K between the side 3 and the face 5, but especially by the presence of the content of the thus-formed box. In conclusion, movement of the wall 11 with respect to wall 1 is prevented.

With this arrangement, an additional compartment 12, like an envelope or similar, is immediately formed inside the face 1 in a manner that is particularly simple to implement as the procedure is the same as in traditional paper-product operations for box-forming and gluing the box between the facing surfaces of the side 7 and the flap 9; this gluing is the only operation that is performed for making the box.

The box must be completed by the closing walls of the main prismatic compartment formed by the parts 11, 13, 5 and 7, one of these closing walls being destined for opening and closing to provide access to the inside of the box. One of these said closing walls, which extends from the fold line 10F delimiting face 1, is indicated in the drawings by reference number 15; a tab 15A extends from this closing wall 15 to provide traditional closure. A second closing wall 17 can be realized beyond the fold line 10G delimiting the dividing wall 11, with a tab 17A that provides closure, this closing wall 17 being such that the tab 17A is immediately inserted inside the face 5.

Alternatively, an equivalent closing wall to wall 17 (see FIG. 5) can be positioned, as indicated by reference 117, as an extension of the face 5 and equipped with a tab 117A, equivalent to tab 17A, but which must immediately close inside the dividing wall 11, as shown in detail in FIG. 6.

After closure of the box in its prismatic form, the box remains closed with access gained by opening the closing wall 15 or the closing wall 17 or, alternatively, the closing wall 117. In all cases the additional compartment 12 is always accessible for accepting or extracting a substantially sheet-like component such as a repeatedly folded instruction or information sheet F; extraction and insertion of the sheet is possible via the aperture 12A that is defined by the dividing wall 11 and face 1, along the edge 1X. This aperture 12A is always accessible for the extraction and insertion of a component such as F, independently of the opening or closing of the main compartment of the box via the closing walls 15, 17 or 117.

Characteristically, and to advantage, an opening 19 is provided in an intermediate position on the face 1 to aid extraction of the component F from the aperture 12A, this opening 19 extending longitudinally, i.e. parallel to the fold lines such as 10E, i.e. orthogonally to the edge 1X. This opening can be obtained either by completely cuffing the border defining it, or by shearing that leaves the material 1Y to be removed, partially integral at the points 19A and defines the area of said opening; these points 19A of connection can be easily cut, such that the portion 1Y of the material of face 1—held by said tear-off points 19A—is still integrally connected to the face 1 of the box. The portion 1Y must be removed—by tearing the connection points 19A—for the initial and first extraction of the component F in the direction of the arrow fA. This allows it to be determined whether the box has been maintained pristine or if the component F has been extracted, as it is necessary to have torn the portion 1Y of the material, breaking the connection points 19A, and manipulated the sheet 4 through the opening 19 in the direction of the arrow fA in FIG. 5 to slide it so that it projects through the aperture 12A.

A box as described can be produced using substantially traditional paper-product machinery. In addition to the traditional operations of folding and gluing the flaps such as those 7 and 9 for closing the body of the box, a mechanized procedure also allows the placement of an information sheet F fed from a pile of sheets, folded and stabilized in the folded arrangement, and which can be mechanically fed one at a time and applied with a small drop of adhesive on each of the punched parts to be manipulated to make the box.

FIG. 2 shows a repeatedly folded sheet F, which is stabilized with an adhesive tab A so that it can be easily manipulated for picking from a pile during the mechanical processing for making the box. A drop of glue C is deposited on a zone that does not disturb the reading of the sheet F, especially a zone which corresponds to a zone C1 of the portion 1Y of the cardboard material of the box.

Thus, the box—itself already “personalized” via printing on its outside surfaces—is already prepared with the information sheet F contained in the additional compartment 12, when the contents for which the box is destined are inserted into the main compartment of the box.

The described and illustrated implementation thus allows many advantages: with regards to production, because all operations substantially correspond to those traditionally used for making boxes, and also for the possibility of exploiting an additional compartment 12 of significant size—substantially corresponding to the extension of the box faces 1 or 5—for the mechanized placement of the information sheet in the box, and also for the possibility of being able to check any initial tampering with the box by the removal of the material 1Y to extract the component F, which cannot be extracted unless the material 1Y covering the opening 19 is removed. The extracted sheet can be easily unfolded by adding an adequate indication on the adhesive tab A to tear it.

It is understood that the drawings only illustrate a simplification, given solely as a practical demonstration of the invention, it being possible to change the shape or arrangements without leaving the scope of the concept that forms the invention. The presence of reference numbers in the attached claims has the purpose of facilitating the reading of the claims with reference to the description and the drawings, and does not limit the scope of protection represented by the claims.

1. A box in cardboard or a similar material for medicines or other products, including a main compartment and an additional compartment—for an information sheet relative to the packaged product—separated with respect to said main compartment by a dividing, said box being defined by four sections forming two opposite faces and two opposite sides and by an appendage for gluing to the inside of one the sides, as well as two closing walls, wherein: one of the two faces presents an opening defined by an incomplete cut line for securing at least a portion of the material covering the opening, which portion must be removed to allow the action of extracting the sheet-like contents of said additional compartment to be effected through said opening; and the glued appendage is shaped approximately like the side to which it is glued and extends to form both the dividing wall that is shaped like a face and is internally adjacent to said face equipped with an opening, and a successive appendage destined to be positioned inside and against the other of said two sides;
characterized in that said additional component is devoid of a closing wall and presents an aperture which is always accessible for the extraction and insertion of said information sheeted independently of the opening or closing of said main compartment.

2. A box according to claim 1, characterized in that one of said closing walls extends from the dividing wall.

3. A box according to claim 1, characterized int hat one of said closing walls extends from the face opposite to the face equipped with the opening.

4. A box according to claim 1, characterized in that the information sheet is repeatedly folded, stabilized in the folded position, and lightly glued to the cardboard material of the box.

5. A box according to claim 1, characterized in that said information sheet is glued to said portion covering said opening, that must be removed to allow extraction of said sheet.

6. A box according to claim 1, characterized in that said portion of material covering said opening is smaller than said opening.

7. A procedure for the automated production of a box according to claim 1, including the steps of creating a dividing wall and of a contiguous appendage, destined to form a stabilizing flap for said wall, characterized in that the information sheet is folded, stabilized with a tear-off adhesive and fed—after light gluing—during making of the box for gluing onto one of the walls of the additional compartment, during the paper-product machining processes.

8. A procedure according to claim 7, characterized in that said dividing wall is formed as an extension of the flap destined to be glued for making the body of the box.

9. A procedure according to claim 7, characterized in that in the external face an opening is formed having a portion (held on by anchoring sections that can be torn to allow removal of said portions.

10. A procedure according to claim 9, characterized in that the sheet is glued to the inside surface of said portion.
